(19) United States
(12) Patent Application Publication
(10) Pub. No.: US 2017/0186233 A1
(43) Pub. Date: Jun. 29, 2017

(54) METHOD AND ELECTRONIC DEVICE FOR IMPLEMENTING PAGE SCROLLING SPECIAL EFFECT

(71) Applicants: Le Holdings (Beijing) Co., Ltd., Beijing (CN); Le Shi Zhi Xin Electronic Technology (Tianjin) Limited, Binhai New Area (CN)

(72) Inventor: Xiaofei XU, Binhai New Area (CN)

(21) Appl. No.: 15/236,845

(22) Filed: Aug. 15, 2016

Related U.S. Application Data
(63) Continuation of application No. PCT/CN2016/089566, filed on Jul. 10, 2016.

(30) Foreign Application Priority Data
Dec. 27, 2015 (CN) 2015110058094

(51) Int. Cl. G06T 19/00; G06F 3/0485; G06T 13/20; G06T 17/10; G06T 7/60; G06T 7/00

(52) U.S. Cl. CPC G06T 19/006; G06T 7/60; G06T 7/0085; G06T 13/20; G06T 17/10; G06F 3/0485; G06T 2207/20021; G06T 2200/04

(57) ABSTRACT

Embodiments of the present disclosure relate to the field of video processing technologies, and disclose a method and electronic device for achieving a page scrolling special effect. In some embodiments of the present application, a virtual reality (VR) image having transparency is acquired; a three-dimensional page scrolling model is constructed by using a central point of a quadrangle as an origin of the three-dimensional page scrolling model, and using a plane where the quadrangle is located as an XY plane, and in the three-dimensional page scrolling model, point coordinates on the quadrangle are converted into point coordinates after page scrolling, where a size of the quadrangle is consistent with that of the VR image, and the three-dimensional page scrolling model is rendered according to the VR image having transparency, to obtain a VR image having a page scrolling special effect. By using the embodiments of the present invention, a VR image having transparency is enabled to have a hierarchical sense, thereby increasing a sense of reality of page scrolling, and improving a sense of immersion of watching.

### CROSS-REFERENCE TO RELATED APPLICATIONS

This application is a continuation of PCT application No. PCT/CN2016/089566 submitted on Jul. 10, 2016, and claims priority to Chinese Patent Application No. 201511005809.4, filed on Dec. 27, 2015 and entitled “METHOD AND SYSTEM FOR IMPLEMENTING PAGE SCROLLING SPECIAL EFFECT,” the entire contents of which are incorporated herein by reference.

### TECHNICAL FIELD

This patent application relates to the field of video processing technologies, and more particularly, to a method and electronic device for achieving a page scrolling special effect.

### BACKGROUND

Watching a video in spare time is an indispensable part of daily life of people. With prosperous development of video technologies, various types of video sources show blowout growth, and provide a large quantity of choices for a user to watch a movie. Currently, there are many types of videos, for example, common videos, 360 videos, or 3D videos. Moreover, with constant improvement of the yield and quality of 3D videos, and rapid development of movie watching technologies, people can hopefully watch various types of 3D videos by using a 3D television at home, and can also conveniently watch various types of 3D videos by using a mobile terminal.

The inventors have found, in the process of implementing the present invention, that a video application needs to provide a video preview function to make it convenient for a user to watch a video. However, a current video preview function is only to intercept a frame of a video image of a recommended video to display, or play a part of content in the video in real time, thus failing to vividly present the video content.

### SUMMARY

The present disclosure provides a method and electronic device for achieving a page scrolling special effect, thereby enabling a virtual reality (VR) image having transparency to have a hierarchical sense, increasing a sense of reality of page scrolling, and improving a sense of immersion of watching.

On a first aspect, an embodiment of the present disclosure provides a method for achieving a page scrolling special effect. The method includes the following steps: acquiring a VR image having transparency; constructing a three-dimensional page scrolling model by using a central point of a quadrangle as an origin of the three-dimensional page scrolling model, and using a plane where the quadrangle is located as an XY plane, and converting, in the three-dimensional page scrolling model, point coordinates on the quadrangle into point coordinates after page scrolling, where a size of the quadrangle is consistent with that of the VR image, and pixel values of points in the quadrangle have a mapping relationship to pixel values of points on the VR image; and rendering the three-dimensional page scrolling model to obtain a VR image having a page scrolling special effect.

On a second aspect, an embodiment of the present disclosure provides a non-volatile computer storage medium, including computer executable instructions; when being executed by at least one processor, the computer executable instructions enable the processor to perform the above method.

On a third aspect, an embodiment of the disclosure further provides an electronic device, including: at least one processor; and a memory, where the memory stores instructions that can be executed by the at least one processor, and the execution of the instructions by the at least one processor causes the at least one processor to perform any of the forgoing methods for achieving a page scrolling special effect of the application.

According to the method and electronic device for achieving a page scrolling special effect provided by the embodiment of the present disclosure, three-dimensional modeling is performed on the VR image having transparency, that is, a three-dimensional page scrolling model is constructed by using a central point of a quadrangle as an origin and by using a plane where the quadrangle is located as an XY plane, in the three-dimensional page scrolling model, point coordinates on the quadrangle are converted into point coordinates after page scrolling, and the three-dimensional page scrolling model after coordinate conversion is rendered according to the VR image having transparency, to obtain a VR image having a page scrolling special effect. Therefore, according to the embodiment of the present disclosure, a page scrolling effect is achieved by using coordinate conversion of a three-dimensional model, thereby enabling a VR image having transparency to have a hierarchical sense, increasing a sense of reality of page scrolling, and improving a sense of immersion of watching by a user.

In an embodiment, in the step of constructing the three-dimensional page scrolling model, the quadrangle is segmented along the page scrolling direction, to obtain multiple grids; and in the step of rendering the three-dimensional page scrolling model, all the grids are sequentially rendered according to an ascending order of Z values of the grids. The rending manner can enable the page scrolling effect to be more real.

In an embodiment, the width of each grid obtained by segmentation is less than the radius of page scrolling. Therefore, the VR image can be segmented according to a size of the radius of page scrolling, to obtain a more delicate page scrolling effect.

In an embodiment, in the step of segmenting the quadrangle, the quadrangle is divided at equal intervals. In this way, the page scrolling effect has good fluency; fidelity of the page scrolling effect is increased; and a sense of immersion of watching by a user is increased.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart illustrating a method for achieving a page scrolling special effect according to Embodiment 1 of the present disclosure;

FIG. 2 is a schematic diagram illustrating page scrolling of a three-dimensional page scrolling model according to Embodiment 1 of the present disclosure;

FIG. 3 is a schematic diagram illustrating a VR image before page scrolling of the method for achieving a page scrolling special effect according to Embodiment 1 of the present disclosure;

FIG. 4 is an effect exemplary diagram illustrating a VR image after page scrolling according to FIG. 3; and

FIG. 5 is a structural schematic diagram illustrating a system for achieving a page scrolling special effect according to Embodiment 2 of the present disclosure;

FIG. 6 is a schematic structural diagram of an electronic device according to Embodiment 4 of the present disclosure.

### DETAILED DESCRIPTION

To make the objectives, technical solutions, and advantages of the disclosure clearer, hereinafter, the technical solutions of the disclosure will be clearly and completely described by implementation manners with reference to the accompanying drawings in the embodiments of the disclosure. Apparently, the described embodiments are a part rather than all of the embodiments of the disclosure.

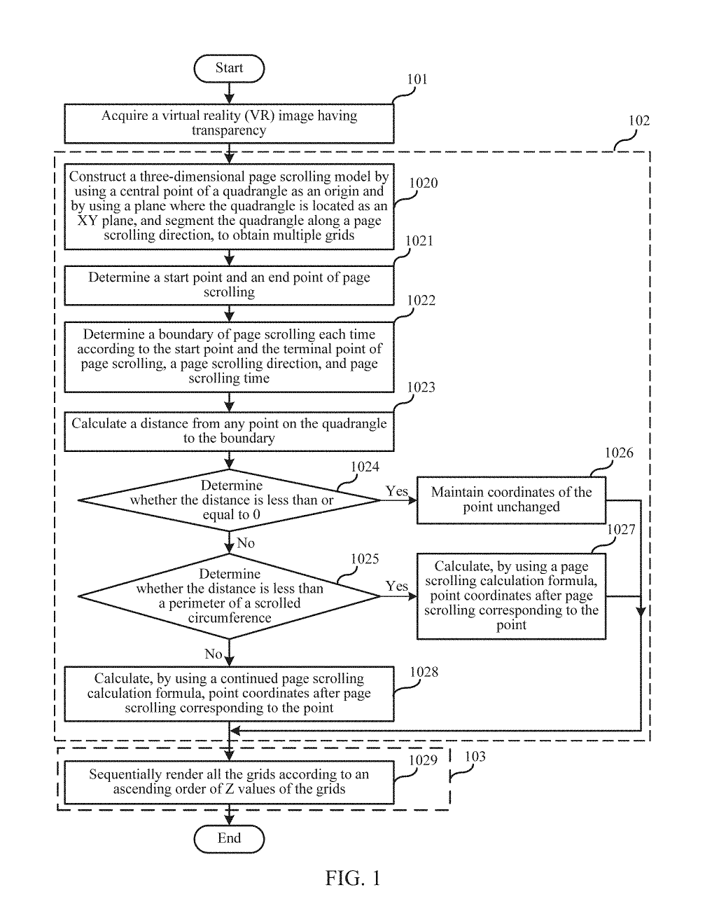

Embodiment 1 of the present disclosure relates to a method for achieving a page scrolling special effect, and the specific process is as illustrated in FIG. 1. The method includes the following steps.

Step 101: A VR image having transparency is acquired.

Transparency refers to a degree of transparency or translucence of a picture, and can affect an effect of overlapping multiple pictures; in particular, with development of 3D videos and virtual reality (VR in short) technologies, a large quantity of VR movies and pictures is generated; and a large quantity of images having transparent exist in the VR movies and pictures.

Step 102: A three-dimensional page scrolling model is constructed by using a central point of a quadrangle as an origin of the three-dimensional page scrolling model and by using a plane where the quadrangle is located as an XY plane, and in the three-dimensional page scrolling model, point coordinates on the quadrangle are converted into point coordinates after page scrolling. In this embodiment, a size of the quadrangle is consistent with that of the VR image, and pixel values of points in the quadrangle have a mapping relationship to pixel values of points on the VR image. Specifically, constructing the three-dimensional page scrolling model includes substeps 1020-1028.

Substep 1020: A three-dimensional page scrolling model is constructed by using a central point of a quadrangle as an origin and by using a plane where the quadrangle is located as an XY plane, and segment the quadrangle along a page scrolling direction, to obtain multiple grids.

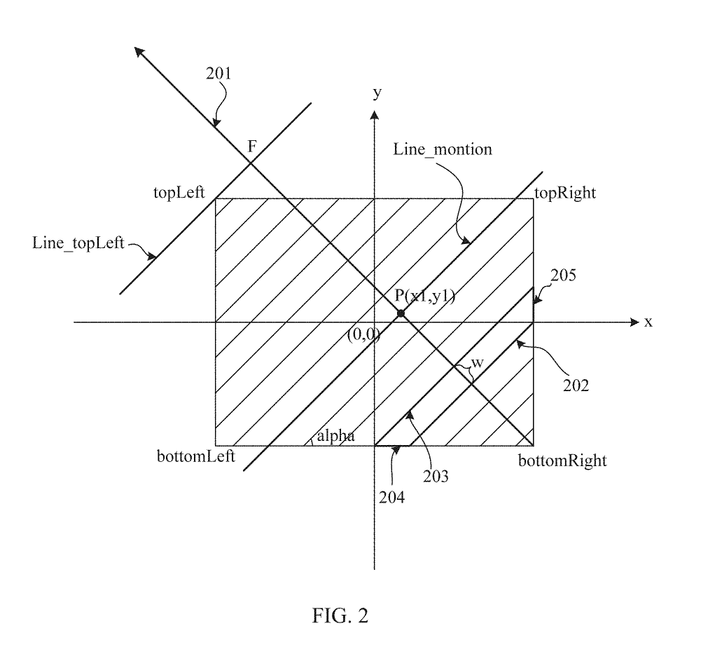

First, the three-dimensional page scrolling model is constructed based on the acquired VR image. As illustrated in FIG. 2, the three-dimensional page scrolling model is constructed by using a central point of the quadrangle as an origin, and using a plane where the quadrangle is located as an XY plane. The size of the quadrangle is consistent with that of the VR image; that is, page scrolling is performed on the entire VR image. To calculate vertex and texture coordinates of the quadrangle, the quadrangle can be divided into multiple parts along any direction, to obtain n grids; a larger value of n indicates a large number of parts into which the quadrangle is segmented; more accurate ordinates of the three-dimensional page scrolling model indicate a more dedicate effect of page scrolling.

Referring to FIG. 2, assume that four vertices of the quadrangle are respectively topLeft, topRight, bottomLeft, and bottomRight; page scrolling is performed from the bottomRight in a lower right corner to the topLeft in an upper left corner; a page scrolling direction is a direction of line 201 connecting the bottomRight to a point F; then the quadrangle can be segmented along the page scrolling direction; slashes in the quadrangle in FIG. 2 are segmentation lines; all segmentation lines are parallel to each other, and are perpendicular to the connecting line 201. In FIG. 2, two segmentation lines 202 and 203 and some edges 204 and 205 of the quadrangle form a grid.

In addition, it should be noted that segmenting the quadrangle at equal intervals can enable a page scrolling effect to have good fluency, increase fidelity of the page scrolling effect, thereby increasing a sense of immersion of watching by a user. In addition, a width w of each grid obtained by segmentation is less than a radius of page scrolling, and the VR image can be segmented according to a size of the radius of page scrolling, to obtain a more delicate page scrolling effect.

Substep 1021: A start point and an end point of page scrolling are determined.

A start point of page scrolling is a point, which first participates in page scrolling in the page scrolling direction, of each vertex of the quadrangle, and an end point is a point, which finally participates in page scrolling in the page scrolling direction, of each vertex of the quadrangle. In the page scrolling model shown in FIG. 2, the direction of the line 201 connecting the bottomRight to the point F is the page scrolling direction, and it can be seen that the point that first participates in page scrolling is the bottomRight, and the point that finally participates in page scrolling is the topLeft.

Substep 1022: A boundary of page scrolling each time is determined according to the start point and the end point of page scrolling, the page scrolling direction, and page scrolling time.

Specifically, a boundary of page scrolling can be determined by the following steps.

1. A first straight line Line_topLeft that passes through the end point topLeft and is perpendicular to the page scrolling direction is calculated.

Because the segmentation lines in the quadrangle are perpendicular to the page scrolling direction, and the Line_topLeft is also perpendicular to the page scrolling direction, the Line_topLeft is also parallel to the segmentation lines; that is, a parallel line of the segmentation lines may be drawn by using the topLeft to obtain the Line_topLeft.

2. A second straight line (that is, the connecting line 201) that passes through the start point bottomRight and is perpendicular to the first straight line, and an intersection F of the first straight line and the second straight line are calculated.

3. Interpolation is performed from the start point bottomRight to the intersection F along the second straight line 201.

Suppose a page scrolling special effect needs to be completed within time; to implement a delicate page scrolling effect, a period of time can be divided into several sections; page scrolling diagrams of different time are generated with time advancement. A simple method is to divide time into a quantity the same as that of the grids; that is, during page scrolling each time, one grid is advanced forward, and then an interpolation interval is t=time/n. In actual implementation, generally, time is a value from 0 to 1 second.

In actual calculation, t is used as an interpolation factor; first an interpolation point from the bottomRight to the point F is calculated: P(x1, y1)=intp(bottomRight(x, y), F(x, y), t).

Then, via each interpolation point, a third straight line Line_montion that is perpendicular to the second straight line and a normal vector thereof are calculated, where the calculated third straight line is the boundary. Specifically, an angle (that is, an angle alpha in FIG. 2) is known; a slop k=tan(angle), and the point P (x1, y1) is passed through; an equation of the boundary Line_montion is calculated as kx−y+y1−k×1 =0 and the normal vector of the boundary is calculated as N(fX, fY)=(k, −1).

By the above steps, after the boundary of page scrolling each time is determined, in steps 1023 to 1028, the point coordinates on the quadrangle are converted, in the three-dimensional page scrolling model, into the point coordinates after page scrolling.

Substep 1023: A distance from any point on the quadrangle to the boundary is calculated.

If the radius of page scrolling is as R, the distance between any point (x, y) to the straight line line_montion may be calculated by using the following formula:

distance=(k*x+(−1)*y+y1−k*x1)/(k*k+1).

k is an fX component of the normal vector N, and −1 is an fY component of the normal vector N.

Substep 1024: It is determined whether the distance is less than or equal to 0. If the distance is greater than 0, step 1025 is performed; if the distance is less than or equal to 0, step 1026 is performed.

Substep 1025: It is determined whether the distance is less than a perimeter of a scrolled circumference. If the distance is less than the perimeter of the scrolled circumference, step 1027 is performed; if the distance is greater than or equal to the perimeter of the scrolled circumference, step 1028 is performed.

Substep 1026: Coordinates of the point are maintained unchanged, that is, the point does not participate in page scrolling.

Substep 1027: Point coordinates after page scrolling corresponding to the point are calculated by using a page scrolling calculation formula.

If the distance is greater than zero and is less than the perimeter of the scrolled circumference, it indicates that page scrolling starts; and calculation formulas of the point coordinates vertices (x, y, z) after page scrolling are as follows:

ptCoiling.fX=x−N.fX*distance;

ptCoiling.fY=y−N.fY*distance;

vertices.x=ptCoiling.fX+N.fx*sin Alpha;

vertices.y=ptCoiling.fY+N.fY*sin Alpha;

vertices.z=(1−cos(alpha))*R;

in the formulas, Ptcoiling represents coordinates of a point after movement along a two-dimensional direction, and is an intermediate value; ptCoiling.fX and ptCoiling.fY represent two components of the coordinates;

sinAlpha=R*sin(alpha); sin(alpha) and cos(alpha) are respectively a sine value and a cosine value of the angle alpha;

N.fX and N.fY are respectively two components of the normal vector N; and

vertices.x, vertices.y, and vertices.z are respectively three components of the point coordinates after page scrolling.

Substep 1028: Point coordinates after page scrolling corresponding to the point are calculated by using continued page scrolling calculation formula.

If the distance is greater than zero and is greater than the perimeter of the scrolled circumference, it indicates that the points that participate in page scrolling in step 1027 continue to perform scrolling, and the point coordinates vertices(x, y, z) after scrolling are as follows:

beta=distance/[R*(1−t/2)];

sinBeta=R*(1−t/2)*sin(beta);

vertices.x=ptCoiling.fX+N.fx*sin Beta;

vertices.y=ptCoiling.fY+N.fY*sin Beta;

vertices.z=(1−cos(beta))*R*(1−t/2);

in the formulas, sin(beta) and cos(beta) are respectively a sine value and a cosine value of an angle beta.

It should be noted that calculation formulas of page scrolling from the lower right corner to the upper left corner are exemplarily described herein. It should be understood that calculation of coordinates after page scrolling if page scrolling is performed in any direction can be based on suitable modification to the foregoing formulas.

After the three-dimensional page scrolling model is constructed, and the point coordinates on the quadrangle are converted, in the three-dimensional page scrolling model, into the point coordinates after page scrolling, step 103 is performed: rendering, according to the VR image having transparency, the three-dimensional page scrolling model to obtain a VR image having a page scrolling special effect.

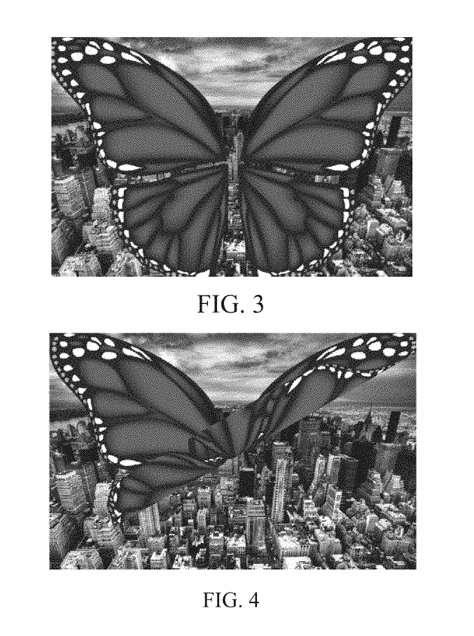

Specifically, because in a phase of constructing the three-dimensional page scrolling model, a mapping relationship has been established for the image texture coordinates (that is, a pixel value of each point); in a subsequent page scrolling process, the texture coordinates do not change, and only the vertex coordinates change. When page scrolling occurs, the image moves with movement of the vertices. FIG. 3 shows an example of a VR image before page scrolling in this embodiment. FIG. 4 is an exemplary diagram of an effect that is after page scrolling and that is obtained by using the page scrolling method in this embodiment.

In addition, it is worth mentioning that all the grids may be sequentially rendered according to an ascending order of Z values of the grids, such that the page scrolling effect is more real. The Z values of the grids may be Z coordinate values of central points of the grids.

Therefore, in this embodiment, in a constructed three-dimensional page scrolling model, point coordinates on a quadrangle are converted into point coordinates after page scrolling. In this embodiment, the quadrangle are divided into multiple parts, and the point coordinates after page scrolling are calculated by means of interpolation. Therefore, a page scrolling effect may be presented in real time according to a rhythm of page scrolling, such that a VR image has a strong hierarchical sense, thereby increasing a sense of reality when previewing a VR movie or picture and the like, and improving a sense of immersion of watching a movie by a user.

The step divisions of the various methods as described above are only for description clarity, and in specific implementation, the steps may be combined into one step, or some steps can be decomposed into multiple steps for each; as long as the steps include the same logic relationship, the steps are within the protection scope of the present patent; adding insignificant modifications or introducing insignificant designs into an algorithm or a process does not change core designs of the algorithm or process, where the core designs of the algorithm or process are within the protection scope of the patent.

Embodiment 2 of the present disclosure relates to a system for achieving a page scrolling special effect. The system for achieving a page scrolling special effect may be applied in various types of video applications, and include an acquiring module 510, a modeling module 520, and a rendering module 530, as illustrated in FIG. 5.

The acquiring module 510 is configured to acquire a VR image having transparency.

The modeling module 520 is configured to construct a three-dimensional page scrolling model by using a central point of a quadrangle as an origin of the three-dimensional page scrolling model, and using a plane where the quadrangle is located as an XY plane, and is further configured to segment the quadrangle along the page scrolling direction, to obtain multiple grids, and convert, in the three-dimensional page scrolling model, point coordinates on the quadrangle segmented into multiple parts into point coordinates after page scrolling. A size of the quadrangle is consistent with that of the VR image, and pixel values of points in the quadrangle have a mapping relationship to pixel values of points on the VR image.

The modeling module 520 further includes: a point acquiring module 522, a line acquiring module 524, a distance acquiring module 526, and a page scrolling coordinate calculating module 528. The point acquiring module 522 is configured to determine a start point and an end point of page scrolling, where the start point is a point, which first participates in page scrolling in the page scrolling direction, of each vertex of the quadrangle, and the end point is a point, which finally participates in page scrolling in the page scrolling direction, of each vertex of the quadrangle. The line acquiring module 524 is configured to determine a boundary of page scrolling each time according to the start point and the end point of page scrolling, the page scrolling direction, and page scrolling time. The distance acquiring module is configured to calculate a distance between any point on the quadrangle and the boundary. The page scrolling coordinate calculating module 528 is configured to calculate, by using a page scrolling calculation formula, point coordinates after page scrolling corresponding to the point when the distance calculated by the distance acquiring module is greater than zero and is less than a perimeter of a scrolled circumference; and calculate, by using a continued page scrolling calculation formula, point coordinates after page scrolling corresponding to the point when the distance calculated by the distance acquiring module 526 is greater than or equal to the perimeter of the scrolled circumference. The perimeter of the scrolled circumference is obtained by calculation according to the radius of page scrolling, and a calculation formula of point coordinates after page scrolling is the same as that in Embodiment 1, and details are not described herein again.

The rendering module 530 is configured to render the three-dimensional page scrolling model according to the VR image having transparency, that is, sequentially render all the grids according to an ascending order of Z values of the grids, to obtain a VR image having a page scrolling special effect.

It is not difficult to find that this embodiment is a device embodiment corresponding to Embodiment 1. This embodiment may be implemented in cooperation with Embodiment 1. Relevant technical details mentioned in Embodiment 1 are still effective in this embodiment. To reduce repetition, details are not described herein again. Correspondingly, relevant technical details mentioned in this embodiment may also applied in Embodiment 1.

It is worth mentioning that the modules involved in this embodiment are all logic modules. In actual application, a logic unit may be a physical unit, and may be also a part of a physical unit, and may be further implemented by using a combination of multiple physical units. In addition, to highlight an innovative part of the present application, this embodiment does not introduce units that are not closely related to resolving the technical problem proposed in the present application. However, it does not indicate that other units do not exist in this embodiment.

The steps of a method or an algorithm described in combination with embodiments disclosed herein may be directly embodied in hardware, in a software module executed by a processor, or in a combination of the two. The software module may reside in a random access memory (RAM), a flash memory, a read only memory (ROM), a programmable read only memory (PROM), an erasable read only memory (PROM), an erasable programmable read only memory (EPROM), an electrically erasable programmable read only memory (EEPROM), a register, a hard disk, a removable disk, a compact disc read-only memory (CD-ROM), or any other form of storage medium known in the art. In the alternative, the storage medium may integrated in the processor. The processor and the storage medium may be configured in an application-specific integrated circuit (ASIC). The ASIC may be configured in a calculation apparatus or a user terminal. In the alternative, the processor and the storage medium may be configured as discrete components in a calculation apparatus or a user terminal.

Embodiment 3 of the application provides a non-volatile computer storage medium, which stores computer executable instructions, where the computer executable instructions can be executed to perform a method for achieving a page scrolling special effect of any of the foregoing method embodiments of the disclosure.

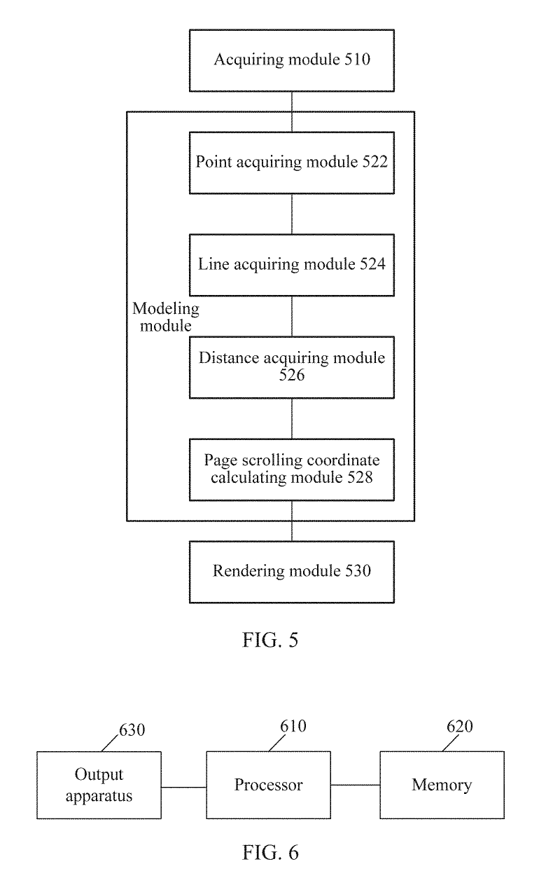

FIG. 6 is a schematic structural diagram of hardware of an electronic device for executing a method for achieving a page scrolling special effect provided by Embodiment 4 of the disclosure. As shown in FIG. 6, the device includes:

one or more processors 610 and a memory 620, with one processor 610 as an example in FIG. 6.

A device for executing the method for achieving a page scrolling special effect may further include: an output apparatus 630.

The processor 610, the memory 620, and the output apparatus 630 can be connected by means of a bus or in other manners, with a connection by means of a bus as an example in FIG. 6.

As a non-volatile computer readable storage medium, the memory 620 can be used to store non-volatile software programs, non-volatile computer executable programs and modules, for example, a program instruction/module corresponding to the method for achieving a page scrolling special effect in the embodiments of the application (for example, an acquiring module 510, a modeling module 520, and a rendering module 530 shown in FIG. 5). The processor 610 executes various functional applications and data processing of the server, that is, implements the method for achieving a page scrolling special effect of the foregoing method embodiments, by running the non-volatile software programs, instructions, and modules stored in the memory 620.

The memory 620 may include a program storage area and a data storage area, where the program storage area may store an operating system and at least one application needed by function; the data storage area may store data created according to use of a system for achieving a page scrolling special effect, and the like. In addition, the memory 620 may include a high-speed random access memory, and also may include a non-volatile memory, such as at least one disk storage device, flash storage device, or other non-volatile solid-state storage devices. In some embodiments, the memory 620 optionally includes memories remotely disposed with respect to the processor 610, and the remote memories may be connected, via a network, to the system for achieving a page scrolling special effect. Examples of the foregoing network include but are not limited to: the Internet, an intranet, a local area network, a mobile communications network, and a combination thereof.

The output apparatus 630 may include a display device, for example, a display screen, etc., configured to display a page scrolling special effect after the rendering module rendering.

The one or more modules are stored in the memory 620, and execute the method for achieving a page scrolling special effect in any one of the foregoing method embodiments when being executed by the one or more processors 610.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

1. A method for achieving a page scrolling special effect applied in an electronic device, comprising:
acquiring a virtual reality (VR) image having transparency;
constructing a three-dimensional page scrolling model by using a central point of a quadrangle as an origin of the three-dimensional page scrolling model, and using a plane where the quadrangle is located as an XY plane, and converting, in the three-dimensional page scrolling model, point coordinates on the quadrangle into point coordinates after page scrolling, wherein a size of the quadrangle is consistent with that of the VR image, and pixel values of points in the quadrangle have a mapping relationship to pixel values of points on the VR image; and
rendering the three-dimensional page scrolling model to obtain a VR image having a page scrolling special effect.

2. The method for achieving a page scrolling special effect according to claim 1, wherein the step of constructing the three-dimensional page scrolling model comprises the following substeps:
determining a start point and an end point of page scrolling, wherein the start point is a point, which first participates in page scrolling in a page scrolling direction, of each vertex of the quadrangle, and the end point is a point, which finally participates in page scrolling in the page scrolling direction, of each vertex of the quadrangle; and
determining a boundary of page scrolling each time according to the start point and the end point of page scrolling, the page scrolling direction, and page scrolling time;
the step of converting, in the three-dimensional page scrolling model, point coordinates on the quadrangle into point coordinates after page scrolling comprises following substeps:
calculating a distance between any point on the quadrangle and the boundary; if the calculated distance is greater than zero and is less than a perimeter of a scrolled circumference, calculating, by using a page scrolling calculation formula, point coordinates after page scrolling corresponding to the point; and
if the calculated distance is greater than or equal to the perimeter of the scrolled circumference, calculating, by using a continued page scrolling calculation formula, point coordinates after page scrolling corresponding to the point;
wherein the perimeter of the scrolled circumference is calculated according to a radius of page scrolling.

3. The method for achieving a page scrolling special effect according to claim 2, wherein the step of determining a boundary of page scrolling each time according to the start point and the end point of page scrolling, the page scrolling direction, and page scrolling time comprises the following substeps:
calculating a first straight line that passes through the end point and is perpendicular to the page scrolling direction;
calculating a second straight line that passes through the start point and is perpendicular to the first straight line, and an intersection of the first straight line and the second straight line;
performing interpolation from the start point to the intersection along the second straight line; and
via each interpolation point, calculating a third straight line that is perpendicular to the second straight line and a normal vector thereof, wherein the third straight line is the boundary.

4. The method for achieving a page scrolling special effect according to claim 1, wherein in the step of constructing the three-dimensional page scrolling model, the quadrangle is divided along the page scrolling direction, to obtain multiple grids; and
in the step of rendering the three-dimensional page scrolling model, sequentially rendering all the grids according to an ascending order of Z values of the grids.

5. The method for achieving a page scrolling special effect according to claim 4, wherein the width of each divided grid is less than the radius of page scrolling.

6. The method for achieving a page scrolling special effect according to claim 4, wherein in the step of dividing the quadrangle, the quadrangle is divided at equal intervals.

7. The method for achieving a page scrolling special effect according to claim 4, wherein the Z values of the grids are Z coordinate values of central points of the grids.

8-10. (canceled)

11. A non-volatile computer storage medium storing computer executable instructions, wherein the computer executable instructions are configured to:
acquire a virtual reality (VR) image having transparency;
construct a three-dimensional page scrolling model by using a central point of a quadrangle as an origin of the three-dimensional page scrolling model, and use a plane where the quadrangle is located as an XY plane, and converting, in the three-dimensional page scrolling model, point coordinates on the quadrangle into point coordinates after page scrolling, wherein a size of the quadrangle is consistent with that of the VR image, and pixel values of points in the quadrangle have a mapping relationship to pixel values of points on the VR image; and
render the three-dimensional page scrolling model to obtain a VR image having a page scrolling special effect.

12. An electronic device, comprising:
at least one processor; and
a memory in communication connection with the at least one processor, where the memory stores instructions that can be executed by the at least one processor, and wherein the execution of the instructions by the at least one processor causes the at least one processor to:
acquire a virtual reality (VR) image having transparency;
construct a three-dimensional page scrolling model by using a central point of a quadrangle as an origin of the three-dimensional page scrolling model, and use a plane where the quadrangle is located as an XY plane, and convert, in the three-dimensional page scrolling model, point coordinates on the quadrangle into point coordinates after page scrolling, wherein a size of the quadrangle is consistent with that of the VR image, and pixel values of points in the quadrangle have a mapping relationship to pixel values of points on the VR image; and
render the three-dimensional page scrolling model to obtain a VR image having a page scrolling special effect.

13. The non-volatile computer storage medium according to claim 11, wherein to construct the three-dimensional page scrolling model, the at least one processor is caused to:
determine a start point and an end point of page scrolling, wherein the start point is a point, which first participates in page scrolling in a page scrolling direction, of each vertex of the quadrangle, and the end point is a point, which finally participates in page scrolling in the page scrolling direction, of each vertex of the quadrangle; and
determine a boundary of page scrolling each time according to the start point and the end point of page scrolling, the page scrolling direction, and page scrolling time;
to convert, in the three-dimensional page scrolling model, point coordinates on the quadrangle into point coordinates after page scrolling the at least one processor is caused to:
calculate a distance between any point on the quadrangle and the boundary;
if the calculated distance is greater than zero and is less than a perimeter of a scrolled circumference, calculate, by using a page scrolling calculation formula, point coordinates after page scrolling corresponding to the point; and
if the calculated distance is greater than or equal to the perimeter of the scrolled circumference, calculate, by using a continued page scrolling calculation formula, point coordinates after page scrolling corresponding to the point;
wherein the perimeter of the scrolled circumference is calculated according to a radius of page scrolling.

14. The non-volatile computer storage medium according to claim 13, wherein to determine a boundary of page scrolling each time according to the start point and the end point of page scrolling, the page scrolling direction, and page scrolling time, the at least one processor is caused to:
calculate a first straight line that passes through the end point and is perpendicular to the page scrolling direction;
calculate a second straight line that passes through the start point and is perpendicular to the first straight line, and an intersection of the first straight line and the second straight line;
perform interpolation from the start point to the intersection along the second straight line; and
via each interpolation point, calculate a third straight line that is perpendicular to the second straight line and a normal vector thereof, wherein the third straight line is the boundary.

15. The non-volatile computer storage medium according to claim 11, wherein to construct the three-dimensional page scrolling model, the at least one processor is caused to divide the quadrangle along the page scrolling direction to obtain multiple grids; and
wherein to render the three-dimensional page scrolling model, the at least one processor is caused to sequentially render all the grids according to an ascending order of Z values of the grids.

16. The non-volatile computer storage medium according to claim 15, wherein the width of each divided grid is less than the radius of page scrolling.

17. The non-volatile computer storage medium according to claim 15, wherein to divide the quadrangle, the quadrangle is divided at equal intervals.

18. The non-volatile computer storage medium according to claim 15, wherein the Z values of the grids are Z coordinate values of central points of the grids.

19. The electronic device according to claim 12, wherein to construct the three-dimensional page scrolling model, the at least one processor is caused to:
determine a start point and an end point of page scrolling, wherein the start point is a point, which first participates in page scrolling in a page scrolling direction, of each vertex of the quadrangle, and the end point is a point, which finally participates in page scrolling in the page scrolling direction, of each vertex of the quadrangle; and
determine a boundary of page scrolling each time according to the start point and the end point of page scrolling, the page scrolling direction, and page scrolling time;
to convert, in the three-dimensional page scrolling model, point coordinates on the quadrangle into point coordinates after page scrolling the at least one processor is caused to:
calculate a distance between any point on the quadrangle and the boundary; if the calculated distance is greater than zero and is less than a perimeter of a scrolled circumference, calculate, by using a page scrolling calculation formula, point coordinates after page scrolling corresponding to the point; and
if the calculated distance is greater than or equal to the perimeter of the scrolled circumference, calculate, by using a continued page scrolling calculation formula, point coordinates after page scrolling corresponding to the point;
wherein the perimeter of the scrolled circumference is calculated according to a radius of page scrolling.

20. The electronic device according to claim 19, wherein to determine a boundary of page scrolling each time according to the start point and the end point of page scrolling, the page scrolling direction, and page scrolling time, the at least one processor is caused to:
calculate a first straight line that passes through the end point and is perpendicular to the page scrolling direction;
calculate a second straight line that passes through the start point and is perpendicular to the first straight line, and an intersection of the first straight line and the second straight line;
perform interpolation from the start point to the intersection along the second straight line; and
via each interpolation point, calculate a third straight line that is perpendicular to the second straight line and a normal vector thereof, wherein the third straight line is the boundary.

21. The electronic device according to claim 12, wherein to construct the three-dimensional page scrolling model, the at least one processor is caused to divide the quadrangle along the page scrolling direction, to obtain multiple grids; and
wherein to render the three-dimensional page scrolling model, the at least one processor is caused to sequentially render all the grids according to an ascending order of Z values of the grids.

22. The electronic device according to claim 21, wherein the width of each divided grid is less than the radius of page scrolling.

23. The electronic device according to claim 21, wherein to divide the quadrangle, the quadrangle is divided at equal intervals.
